(19) United States
(12) Patent Application Publication
(10) Pub. No.: US 2007/0126941 A1
(43) Pub. Date: Jun. 7, 2007

(54) Liquid crystal display with different capacitances for different colored sub-pixel units thereof

(75) Inventor: Yung-Chiang Cheng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/607,308

(22) Filed: Dec. 1, 2006

(30) Foreign Application Priority Data
Dec. 1, 2005 (CN) 200510102125.6

(51) Int. Cl. G02F 1/1343

(52) U.S. Cl. 349/38

(57) ABSTRACT

An exemplary liquid crystal display (200) includes a plurality of gate lines (221) and data lines (222). The gate and data lines are crossed each other cooperatively defining a plurality of pixel units, and each of the pixel unit includes a red, green, blue sub-pixel unit (230), a green sub-pixel unit, and a blue sub-pixel unit. The red, green, and blue sub-pixel unit includes a common electrode, a pixel electrode (224) and a storage capacitor (225) respectively. The common electrode and the pixel electrode in each sub-pixel unit cooperatively defining a liquid crystal capacitor (227) which is connected in parallel with the cooperative liquid crystal capacitor. A capacitance value of the storage capacitor of each of the other two of the red, green, and blue sub-pixel unit is different.

### FIELD OF THE INVENTION

The present invention relates to driving circuits for liquid crystal panels of liquid crystal displays, and more particularly to a liquid crystal display having a simple driving circuit and having different capacitance values for storage capacitors of different colored sub-pixel units in each of pixel units of a liquid crystal panel.

### GENERAL BACKGROUND

An image on the screen of a typical liquid crystal display (LCD) is made up of a multiplicity of pixels. A liquid crystal display panel which houses the screen is commonly defined as including a multiplicity of pixel units, with the pixel units corresponding to the pixels. Each pixel unit includes a red sub-pixel unit, a green sub-pixel unit, and a blue sub-pixel unit, defined according to corresponding red, green, and blue color filters thereof. Each red, green, and blue sub-pixel unit includes a pixel electrode, a common electrode, and a portion of a liquid crystal layer interposed therebetween. Variation of the so-called pixel voltage of the pixel electrode changes the tilt angle of liquid crystal molecules of the liquid crystal layer thereat. The change in orientation of the liquid crystal molecules alters the proportion of light transmission therethrough. Thereby, the sub-pixel units cooperate to provide a desired emission of light from each pixel unit, and the emissions of light from all the pixel units cooperatively form an image for display on the screen. A general relation between a pixel voltage and a light transmission rate of the corresponding sub-pixel unit is illustrated as a light transmission curve in FIG. 4.

The pixel voltage is nonlinear in relation to the resulting light transmission rate. However, the inputted signal for driving the pixel electrode is designed to be linear in relation to the light transmission rate. Therefore, a gray-scale output circuit is provided for adjusting the inputted single to obtain a corresponding desired pixel voltage.

The relation between the light transmission rate and the pixel voltage of a pixel electrode in each of red (R), green (G), and blue (B) sub-pixel units is shown as three light transmission curves in FIG. 5. The pixel voltages of these pixel electrodes can be designated as Vr, Vg, and Vb respectively. The relation among these pixel voltages under a same light transmission rate is Vr<Vg<Vb.

The light transmission rate of each sub-pixel unit is determined by the corresponding inputted signal. Therefore three individual gray-scale output circuits are provided for transferring the corresponding inputted signal before driving each pixel electrode; namely, a red gray-scale output circuit, a green gray-scale output circuit, and a blue gray-scale output circuit.

A conventional liquid crystal display 100 is schematically illustrated in FIG. 6. The liquid crystal display 100 includes a driving circuit 110, and a liquid crystal display panel 120 connected to the driving circuit 110. The driving circuit 110 includes a common gray-scale input circuit 111, a red gray-scale output circuit 112, a green gray-scale output circuit 113, a blue gray-scale output circuit 114, and a gamma circuit 115. The common gray-scale input circuit 111, and the red, green, and blue gray-scale output circuits 112, 113, 114 are respectively connected to the gamma circuit 115.

The liquid crystal display panel 120 includes a plurality of pixel units. An exemplary one of the pixel units is schematically shown in FIG. 7. The pixel unit (not labeled) includes three sub-pixel units 130. The three sub-pixel units 130 are a red sub-pixel unit 130, a green sub-pixel unit 130, and a blue sub-pixel unit 130, defined according to their corresponding color filters (not shown). Each sub-pixel unit 130 is defined to include a gate line 121 and a data line 122 that are insulated from and cross each other, a thin film transistor 123, a pixel electrode 124, a common electrode 125, and a storage capacitor 128.

The thin film transistor 123 includes a gate 1231, a source 1232, and a drain 1233. The gate 1231 is connected to the gate line 121, the source 1232 is connected to the data line 122, and the drain 1233 is connected to the pixel electrode 124. The pixel electrode 124 and the common electrode 125 together define a liquid crystal capacitor 127. The liquid crystal capacitor 127 is connected in parallel with the storage capacitor 128, for retaining a voltage of the pixel electrode 124 after the liquid crystal capacitor 127 is charged. The storage capacitors 128 of each red, green, and blue sub-pixel unit 130 all have a same predetermined capacitance value.

When the liquid crystal display 100 is operating, a signal outputted from the common gray-scale input circuit 111 to each pixel electrode 124 of the red, green, and blue sub-pixel units 130 is first adjusted by the red, green, and blue gray-scale output circuits 112, 113, 114 respectively. The adjusted signal is then further adjusted by the gamma circuit 115 before being provided to the pixel electrodes 124 of the red, green, and blue sub-pixel units 130 respectively.

The driving circuit 110 requires the three different gray-scale output circuits 112, 113, 114 for adjusting the pixel voltages of the corresponding sub-pixel units 130 respectively. That is, the structure of the driving circuit 110 is rather complicated, and the cost of the driving circuit 110 is correspondingly high.

Accordingly, what is needed is a liquid crystal display configured to overcome the above-described problems.

### SUMMARY

An exemplary liquid crystal display includes a plurality of gate lines and data lines. The gate lines and the data lines are crossed each other cooperatively defining a plurality of pixel units, and each of the pixel unit includes a red sub-pixel unit, a green sub-pixel unit, and a blue sub-pixel unit. The red sub-pixel unit, green sub-pixel unit, and blue sub-pixel unit includes a common electrode, a pixel electrode and a storage capacitor respectively. The common electrode and the pixel electrode in each red, green, and blue sub-pixel unit cooperatively defining a liquid crystal capacitor which is connected in parallel with the liquid crystal capacitor. A capacitance value of the storage capacitor of each of the other two of the red, green, and blue sub-pixel unit is different.

A detailed description of embodiments of the present invention is given below with reference to the accompanying drawings.

### BRIEF DESCRIPTION OF THE DRAWINGS

In the drawings, all the views are schematic.

FIG. 1 is a schematic diagram of a liquid crystal display in accordance with a first embodiment of the present invention.

FIG. 2 is a schematic, enlarged, top plan view of three sub-pixel units of an exemplary pixel unit of a liquid crystal display panel of the liquid crystal display of FIG. 1, namely a red sub-pixel unit, a green sub-pixel unit, and a blue sub-pixel unit.

FIG. 3 is a graph showing three light transmission curves respectively of the red sub-pixel unit, the green sub-pixel unit, and the blue sub-pixel unit of FIG. 2.

FIG. 4 is a light transmission curve of an exemplary sub-pixel unit of an exemplary pixel unit of a liquid crystal display panel of a conventional liquid crystal display (shown in FIG. 6).

FIG. 5 is a graph showing three light transmission curves respectively of a red sub-pixel unit, a green sub-pixel unit, and a blue sub-pixel unit of the exemplary pixel unit of the conventional liquid crystal display.

FIG. 6 is a schematic diagram of the conventional liquid crystal display.

FIG. 7 is a schematic, enlarged, top plan view of the red sub-pixel unit, the green sub-pixel unit, and the blue sub-pixel unit of the exemplary pixel unit of the conventional liquid crystal display.

### DETAILED DESCRIPTION OF PREFERRED EMBODIMENTS

Referring to FIGS. 1 to 3, a liquid crystal display 200 in accordance with a first embodiment of the present invention includes a driving circuit 210, and a liquid crystal display panel 220 connected to the driving circuit 210. The driving circuit 210 includes a common gray-scale input circuit 211, and a gamma circuit 212 connected to the common gray-scale input circuit 211.

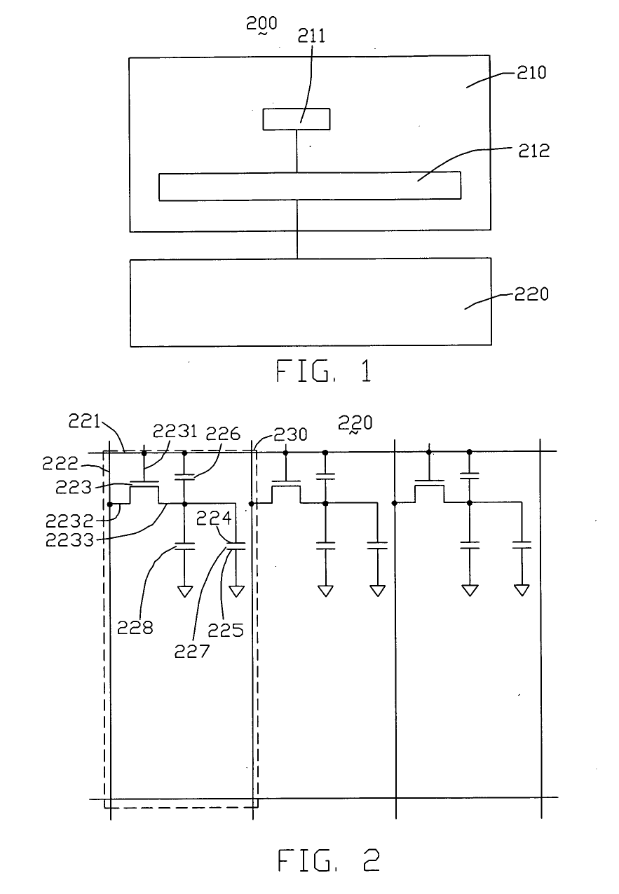

The liquid crystal display panel 220 includes a plurality of pixel units (not labeled). Each pixel unit includes three sub-pixel units 230, as shown in FIG. 2. Each sub-pixel unit 230 is defined to include a gate line 221 and a data line 222 that are insulated from and cross each other. The three sub-pixel units 230 are a red sub-pixel unit 230, a green sub-pixel unit 230, and a blue sub-pixel unit 230, defined according to their corresponding color filters (not shown). Each sub-pixel unit 230 includes the corresponding gate line 221, the corresponding data line 222, a thin film transistor 223, a pixel electrode 224, a common electrode 225, and a storage capacitor 228.

The thin film transistor 223 includes a gate 2231, a source 2232, and a drain 2233. The gate 2231 is connected to the gate line 221, the source 2232 is connected to the data line 222, and the drain 2233 is connected to the pixel electrode 224. A parasitic capacitor 226 is formed between the pixel electrode 224 and the gate line 221, and a liquid crystal capacitor 227 is defined by the pixel and common electrodes 224, 225. The storage capacitor 228 is connected in parallel with the liquid crystal capacitor 227, for retaining a voltage of the pixel electrode 224 after the liquid crystal capacitor 227 is charged.

The capacitance values of the storage capacitors 228 of the red, green, and blue sub-pixel units 130 are designated as Csr, Csg, and Csb respectively, and the relation between these capacitance values is Csr<Csg<Csb.

When the liquid crystal display 200 is operating, firstly, a data signal outputted from the common gray-scale input circuit 211 is first adjusted by the gamma circuit 212 before being provided to the liquid crystal display panel 220. A gate signal is provided to the gate 2231 via the gate line 221, and the data signal is provided to the pixel electrode 224 via the data line 222. Secondly, the gate 2231 is enabled by the gate signal, thereby allowing the data signal to begin charging the pixel electrode 224 via the source 2232 and the drain 2233. Charging continues until the voltage of the pixel electrode 224 is equal to the voltage of the data line 222.

If the voltage of the pixel electrode 224 is lower or higher than the voltage of the common electrode 225 after charging is completed, the voltage of the pixel electrode 224 increases or decreases a little after the source 2232 is disconnected from the drain 2233. The increased or decreased voltage ΔVp is called a feed through voltage.

The capacitance value of the liquid crystal capacitor 227 is designated as Clc, the capacitance value of the storage capacitor 228 is designated as Cst, and the capacitance value of the parasitic capacitor 226 is designated as Cgd. The relation between these capacitance values is as follows:

$$Δ Vp = \frac{Δ Vg \times Cgd}{Cgd + Cst + Clc}$$

ΔVg is the decreased or increased voltage of the gate line 221 causing by the coupling effect with the pixel electrode 224. The voltage of the pixel electrode 224 is Vp, and the voltage of the data line 222 is V. The relation between these three voltages is:
Vp=V−ΔVp

According to the above equations, ΔVp can be controlled by Cst, and Vp is determined by ΔVp. Therefore Vp can be determined by Cst, thereby allowing the pixel electrodes 224 of the three sub-pixel units 230 to have the same pixel voltage Vp and same light transmission rate but be charged by the respective data lines 222 with a same voltage V. The relation between the capacitance values of the three storage capacitors 228 is Csr<Csg<Csb. Therefore the relation between the feed through voltages of the three pixel electrodes 224 ΔVpr, ΔVpg, and ΔVpb is ΔVpr>ΔVpg>ΔVpb, and the relation between the corresponding pixel voltages Vpr, Vpg, and Vpb of the three pixel electrodes 224 is Vpr<Vpg<Vpb. For example, the storage capacitors 228 of the red, green, and blue sub-pixel units 230 have capacitance values Csr=109.7 pF, Csg=220.4 pF, and Csb=315.2 pF respectively for a typical 17 inch liquid crystal display.

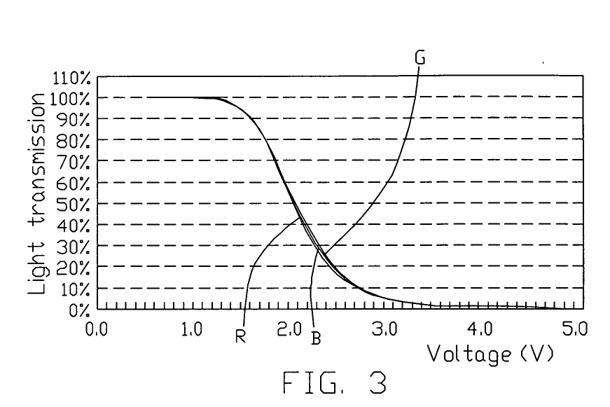

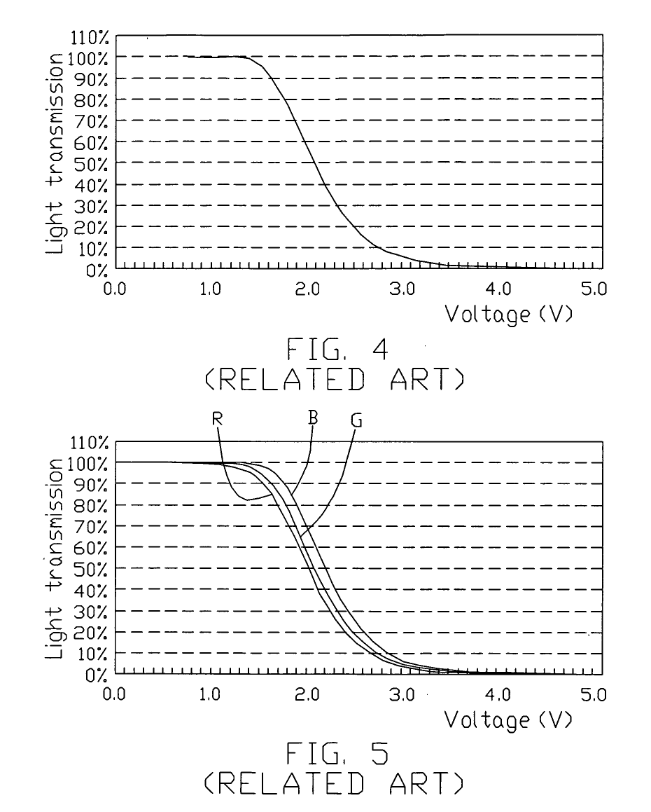

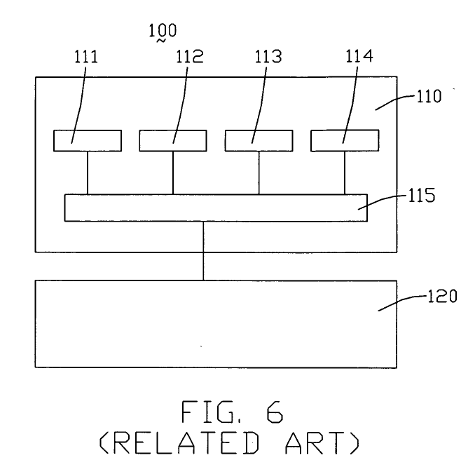

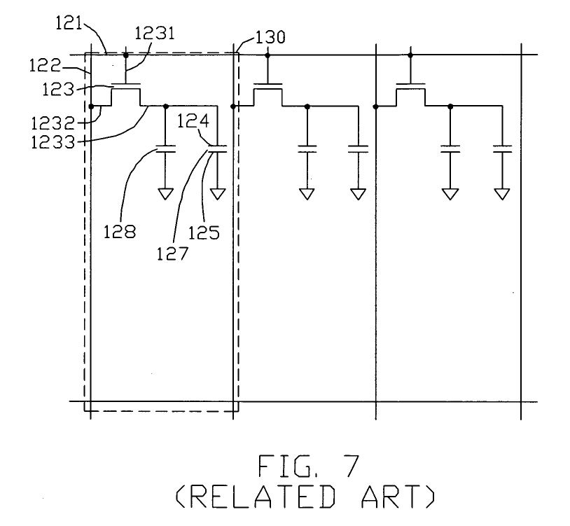

Referring to FIG. 3, this illustrates three light transmission curves of light transmission rate versus corresponding pixel voltage of the pixel electrode 224 of each of the red (R), green (G), and blue (B) sub-pixel units 230. The light transmission curves of the three pixel electrodes 224 substantially match each other, as seen.

Unlike in the above-described conventional liquid crystal display 100, each of the three sub-pixel units 230 of each pixel unit of the liquid crystal display 200 includes a storage capacitor 228 having a different value ΔVp from that of the other two sub-pixel units 230. The three pixel electrodes 224 of the sub-pixel units 230 can be charged by the same inputted signal via the respective data lines 222. The driving circuit 210 only needs the common gray-scale input circuit 211 and the circuit 212. Therefore the structure of the driving circuit 210 is simplified, cost of the driving circuit 210 is reduced.

While examples and a preferred embodiment have been described above, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display, comprising:
a plurality of gate lines and a plurality of data lines that cross each other thereby cooperatively defining a plurality of pixel units, each of the pixel units comprising a red sub-pixel unit, a green sub-pixel unit, and a blue sub-pixel unit, the red sub-pixel unit, the green sub-pixel unit, and the blue sub-pixel unit each comprising a common electrode, a pixel electrode, and a storage capacitor, the common electrode and the pixel electrode in each of the red sub-pixel unit, the green sub-pixel unit, and the blue sub-pixel unit cooperatively defining a liquid crystal capacitor;
wherein in each of the red sub-pixel unit, the green sub-pixel unit, and the blue sub-pixel unit, the storage capacitor is connected in parallel with the liquid crystal capacitor, and a capacitance value of the storage capacitor of each of the red sub-pixel unit, the green sub-pixel unit, and the blue sub-pixel unit is different from the capacitance value of the storage capacitor of each of the other two of the red sub-pixel unit, the green sub-pixel unit, and the blue sub-pixel unit.

2. The liquid crystal display as claimed in claim 1, wherein the capacitance value of the storage capacitor of the blue sub-pixel unit is larger than that of the green sub-pixel unit.

3. The liquid crystal display as claimed in claim 1, wherein the capacitance value of the storage capacitor of the green sub-pixel unit is larger than that of the red sub-pixel unit.

4. The liquid crystal display as claimed in claim 1, further comprising a gamma circuit connected to the data lines.

5. The liquid crystal display as claimed in claim 4, further comprising a common gray-scale input circuit connected to the gamma circuit.

6. A liquid crystal display, comprising:
a liquid crystal panel comprising:
a plurality of gate lines and a plurality of data lines that cross each other thereby cooperatively defining a plurality of pixel units, each of the pixel units comprising a red sub-pixel unit, a green sub-pixel unit, and a blue sub-pixel unit, the red sub-pixel unit, the green sub-pixel unit, and the blue sub-pixel unit each comprising a common electrode, a pixel electrode, and a storage capacitor, the common electrode and the pixel electrode in each of the red sub-pixel unit, the green sub-pixel unit, and the blue sub-pixel unit cooperatively defining a liquid crystal capacitor;
wherein in each of the red sub-pixel unit, the green sub-pixel unit, and the blue sub-pixel unit, the storage capacitor is connected in parallel with the liquid crystal capacitor, and a capacitance value of the storage capacitor of each of the red sub-pixel unit, the green sub-pixel unit, and the blue sub-pixel unit is different from the capacitance value of the storage capacitor of each of the other two of the red sub-pixel unit, the green sub-pixel unit, and the blue sub-pixel unit;
a gamma circuit connected to the data lines; and
a common gray-scale input circuit connected to the gamma circuit.
